(19) United States
(12) Patent Application Publication
(10) Pub. No.: US 2020/0218071 A1
(43) Pub. Date: Jul. 9, 2020

(54) VEHICLE DISPLAY DEVICE

(71) Applicant: YAZAKI CORPORATION, Tokyo (JP)

(72) Inventor: Kunimitsu Aoki, Shizuoka (JP)

(21) Appl. No.: 16/826,093

(22) Filed: Mar. 20, 2020

Related U.S. Application Data
(63) Continuation of application No. PCT/JP2018/031756, filed on Aug. 28, 2018.

(30) Foreign Application Priority Data
Oct. 26, 2017 (JP) 2017-207322

(51) Int. Cl. G02B 27/01; G02B 7/182; B60K 35/00

(52) U.S. Cl. CPC G02B 27/0149; G02B 7/182; G02B 27/0101; B60K 35/00; B60K 2370/178; B60K 2370/1529; B60K 2370/167; B60K 2370/166; G02B 2027/0154

(57) ABSTRACT

A vehicle display device includes: an emitting unit installed on a vehicle and that emits display light; and a final mirror that reflects the display light emitted from the emitting unit toward a windshield provided in a front part of the vehicle in a vehicle longitudinal direction, and that reflects by the windshield the display light toward an eye point side assumed in advance. A rise angle of the windshield at the eye point side with respect to a horizontal direction is 60 degrees or more and 90 degrees or less. The final mirror is placed between the windshield and the eye point with respect to the vehicle longitudinal direction, faces the windshield, and reflects the display light emitted from the emitting unit forward in the vehicle longitudinal direction.

### CROSS-REFERENCE TO RELATED APPLICATION

This application is a continuation application of International Application No. PCT/JP2018/031756 filed on Aug. 28, 2018 which claims the benefit of priority from Japanese Patent Application No. 2017-207322 filed on Oct. 26, 2017 and designating the U.S., the entire contents of which are incorporated herein by reference.

### BACKGROUND OF THE INVENTION

### 1. Field of the Invention

The present invention relates to a vehicle display device.

### 2. Description of the Related Art

For example, as a conventional vehicle display device, Japanese Patent Application Laid-open No. H11-321383 discloses a head-up display for a working vehicle in which a combiner is provided on a transparent member in front of a driver's seat, and optical information is displayed on the combiner. In the head-up display, a predetermined length of the combiner formed by a transparent member is provided on both left and right sides of a virtual central line of the transparent member. A marker for guiding the driver to drive straight forward is displayed on the combiner.

For example, it has been desired that the head-up display disclosed in Patent Literature 1 described above can suitably display an image on a windshield, even when the head-up display is applied to a working vehicle and the like in which the windshield rises from the horizontal direction at a predetermined angle.

### SUMMARY OF THE INVENTION

The present invention has been made in view of the above circumstances, and an object of the present invention is to provide a vehicle display device that can suitably display an image formed by the display light on a windshield that rises from the horizontal direction.

In order to achieve the above mentioned object, a vehicle display device according to one aspect of the present invention includes an emitting unit that is installed on a vehicle and that emits display light; a final mirror that reflects the display light emitted from the emitting unit toward a windshield provided in a front part of the vehicle in a vehicle longitudinal direction, and that reflects by the windshield the display light toward a side of an eye point assumed in advance, and a casing that stores the emitting unit in an internal storage space part, wherein the final mirror is placed between the windshield and the eye point with respect to the vehicle longitudinal direction, faces the windshield, reflects the display light emitted from the emitting unit forward in the vehicle longitudinal direction, and the casing includes an optical path opening part that guides the display light from an inside of the storage space part to an outside of the storage space part, and the vehicle display device further includes: an opening opening/closing driving unit capable of moving the final mirror between a display position and a non-display position, the display position being a position where the final mirror is placed between the windshield and the eye point with respect to the vehicle longitudinal direction, faces the windshield, reflects the display light emitted from the emitting unit toward the windshield at a front side in the vehicle longitudinal direction, and reflects the display light toward the side of the eye point by the windshield, and a non-display position being a position where the final mirror closes the optical path opening part.

According to another aspect of the present invention, in the vehicle display device, it is possible to include that a display position adjustment unit capable of adjusting a display position of an image formed by the display light that has reflected toward the side of the eye point by the windshield, by adjusting a reflection angle of the display light that is reflected toward the windshield by the final mirror, by causing the final mirror to rotate around a rotation axis line along a vehicle width direction intersecting with the vehicle longitudinal direction.

According to still another aspect of the present invention, in the vehicle display device, it is possible to further include that the final mirror is provided outside the storage space part, wherein the optical path opening part guides the display light directed toward the final mirror from the inside of the storage space part, to the outside of the storage space part.

According to still another aspect of the present invention, in the vehicle display device, it is possible to configured that a rise angle of the windshield at the side of the eye point with respect to a horizontal direction is 60 degrees or more and 90 degrees or less.

According to still another aspect of the present invention, in the vehicle display device, it is possible to further include that a meter unit that is placed between the windshield and the eye point with respect to the vehicle longitudinal direction, and that visibly displays vehicle information relating to the vehicle at the eye point, wherein the final mirror is placed between the windshield and the meter unit with respect to the vehicle longitudinal direction, and is provided on a surface at a front side of the meter unit in the vehicle longitudinal direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating a configuration of a vehicle display device according to a first embodiment, and a windshield of a vehicle to which the vehicle display device is applied.

FIG. 2 is a schematic diagram illustrating a configuration of the vehicle display device according to the first embodiment.

FIG. 3 is a schematic diagram illustrating a configuration of a vehicle display device according to a second embodiment, and a windshield of a vehicle to which the vehicle display device is applied.

FIG. 4 is a schematic diagram illustrating a configuration of the vehicle display device according to the second embodiment.

FIG. 5 is a schematic diagram illustrating a configuration of a vehicle display device according to a modification.

FIG. 6 is a schematic diagram illustrating an operation of the vehicle display device according to the modification.

FIG. 7 is a schematic diagram illustrating the operation of the vehicle display device according to the modification.

### DETAILED DESCRIPTION OF THE PREFERRED EMBODIMENTS

Hereinafter, embodiments according to the present invention will be described in detail with reference to the accompanying drawings. However, the present invention is not limited to the embodiments. Moreover, components in the following embodiments include components that can be easily replaced by a person skilled in the art, or components that are substantially the same as those components.

### First Embodiment

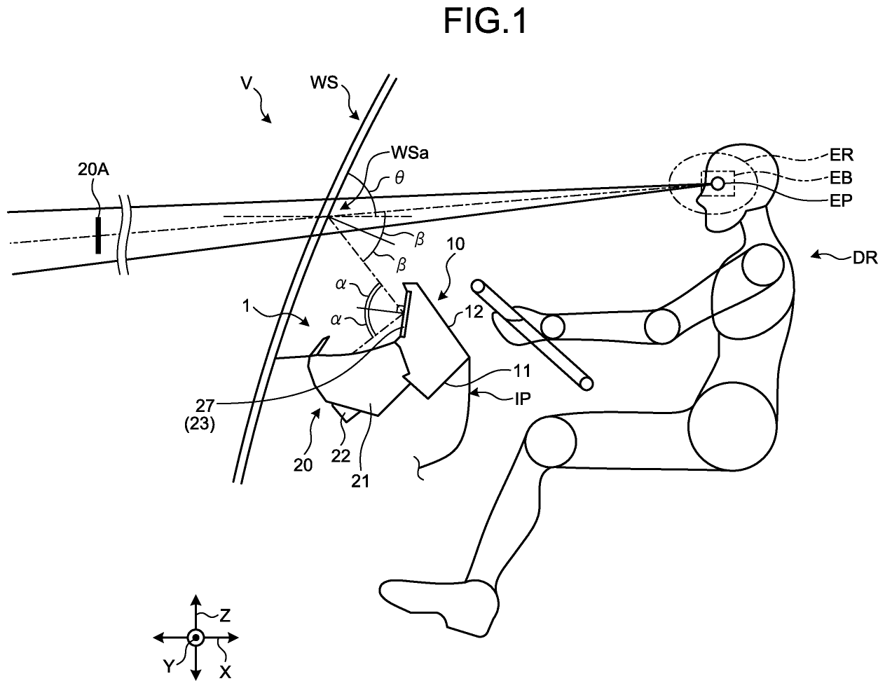

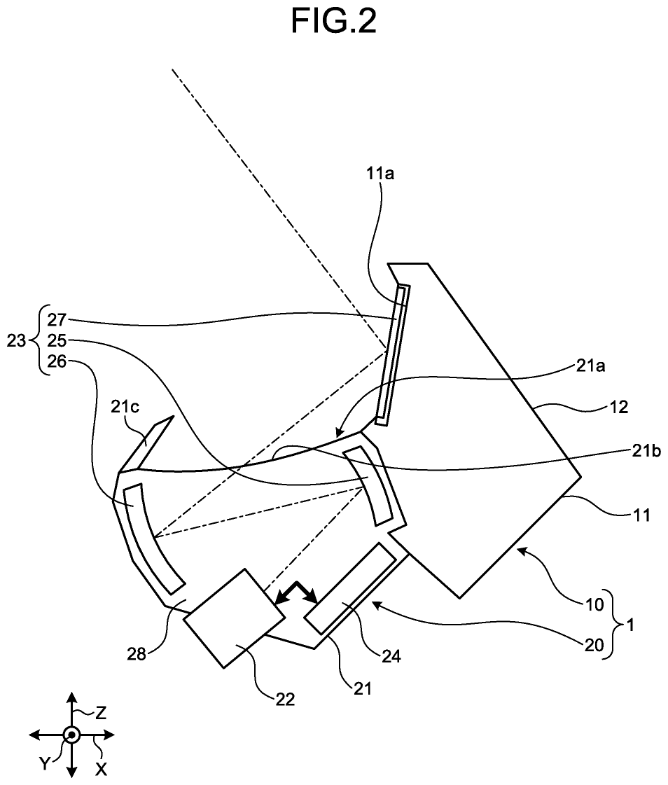

A vehicle display device 1 according to the present embodiment illustrated in FIG. 1 and FIG. 2 is applied to a vehicle V. For example, the vehicle display device 1 is installed in an instrument panel IP provided on a dashboard of the vehicle V. The vehicle display device 1 emits display light toward a windshield WS of the vehicle V, and provides various types of visible information to a driver DR and the like through an image 20A that has reflected toward an eye point EP side by the windshield WS. In this example, the instrument panel IP is an interior member of the vehicle V. The instrument panel IP is provided inside a vehicle chamber in which a driver's seat and the like are provided, and at the front side in a vehicle longitudinal direction X. The instrument panel IP extends along a vehicle width direction Y. Typically, it is assumed in advance that the eye point EP is located inside an eye box EB set within what is called an eye range ER in the vehicle V. The eye range ER is an “eye range of a driver of a vehicle”, and corresponds to an area where the viewpoint of the driver DR is located that is set in advance according to the vehicle V. Typically, the eye range ER is a statistical representation of the eye-position distribution of the driver DR in the vehicle V, and for example, corresponds to an area where the eye position of the driver DR in a predetermined ratio (for example, 95%) is included, while the driver DR is seated on the driver's seat. The eye box EB is placed within the eye range ER, and it is assumed in advance that the eye box EB is a spatial area where the driver DR can suitably view the image 20A when the driver DR is seated on the driver's seat while driving. The windshield WS is formed of a light transmissive member that at least transmits light having components in the visible light region (visible ray). In this example, the light having components in the visible light region is light having wavelength components in the visible light region that can be viewed by human. For example, the light having components in the visible light region is light having wavelength components in a range from 360 to 830 nanometers. The windshield WS is provided in the front part of the vehicle V in the vehicle longitudinal direction X, and may also be referred to as a windscreen. The rise angle θ of the windshield WS of the vehicle V to which the vehicle display device 1 of the present embodiment is applied, at the eye point EP side with respect to the horizontal direction is 60 degrees or more and 90 degrees or less (60°≤θ≤90°), when the vehicle V is on the horizontal plane. The vehicle display device 1 of the present embodiment suitably displays the image 20A formed by the display light on the windshield WS that rises from the horizontal direction in this manner.

The vehicle V to which the vehicle display device 1 of the present embodiment is applied typically includes a working vehicle such as an agricultural machine vehicle (such as a tractor), a construction machine vehicle (such as a crane vehicle and an excavator vehicle), a cleaning vehicle (such as a road cleaning vehicle), and a transportation vehicle (such as a dump vehicle and a truck vehicle). However, it is not limited thereto. As long as the rise angle θ of the windshield WS is 60 degrees or more and 90 degrees or less as described above, the vehicle V may also be a bus, a general passenger car, or the like. Moreover, as long as the rise angle θ of the windshield WS is 60 degrees or more and 90 degrees or less as described above, the vehicle V is not limited to an automobile, and may also be a railway vehicle.

Moreover, in the following explanation, in the vehicle V to which the vehicle display device 1 is applied, the “vehicle longitudinal direction X” typically corresponds to the whole length direction of the vehicle V, and furthermore, corresponds to the direction along the longitudinal advancing direction of the vehicle V. The “vehicle width direction Y” typically corresponds to the whole width direction of the vehicle V, and corresponds to the vehicle horizontal direction of the vehicle V. The “vehicle height direction Z” typically corresponds to the vehicle height direction of the vehicle V. The vehicle longitudinal direction X that is a first direction, the vehicle width direction Y that is a second direction, and the vehicle height direction Z that is a third direction are orthogonal to each other. When the vehicle V is on the horizontal plane, the vehicle longitudinal direction X and the vehicle width direction Y extend along the horizontal direction, and the vehicle height direction Z extends along the vertical direction. Moreover, in the following explanation, in the vehicle longitudinal direction X, the side toward which the vehicle V moves forward may be referred to as “front”, and the side toward which the vehicle V moves rearward may be referred to as “rear”. In the vehicle width direction Y, the left side toward the front in the vehicle longitudinal direction X may be referred to as a “left side”, and the right side toward the front in the vehicle longitudinal direction X may be referred to as a “right side”. In the vehicle height direction Z, the upper side in the vertical direction may be referred to as an “upper side”, and the lower side in the vertical direction may be referred to as a “lower side”. Unless otherwise specified, the directions used in the following explanation indicate directions when the units are assembled with one another. Hereinafter, the configuration of the vehicle display device 1 will be described in detail with reference to the accompanying drawings.

More specifically, as illustrated in FIG. 1 and FIG. 2, the vehicle display device 1 of the present embodiment includes a meter unit 10 and a head up display (HUD) unit (hereinafter, may be referred to as a “HUD unit”) 20. The vehicle display device 1 is a display device unit in which the meter unit 10 and the HUD unit 20 are integrally unitized.

The meter unit 10 is placed between the windshield WS and the eye point EP with respect to the vehicle longitudinal direction X. The meter unit 10 is a portion that displays vehicle information relating to the vehicle V such that the vehicle information can be viewed from the eye point EP. For example, the meter unit 10 is configured when analog-type instruments, digital-type instruments, a display, a direction indication display unit, a shift position indicator, various types of warning lights, and the like are assembled to a meter casing 11. In the meter unit 10, a surface of the meter casing 11 at the side that faces the eye point EP with respect to the vehicle longitudinal direction X, in other words, a surface of the rear side of the meter casing 11 in the vehicle longitudinal direction X forms a meter display unit 12. The meter unit 10 display various types of vehicle information to be used for driving the vehicle V on the meter display unit 12. For example, the vehicle information displayed by the meter unit 10 may also include speed of the vehicle, output rotation speed of the travel power source, accumulated travel distance, cooling water temperature, remaining amount of fuel, battery charge amount, various types of warning lights (warning lamps, what is called a telltale), shift position, direction of the direction indicator, navigation information, and the like. The meter unit 10 is installed in the instrument panel IP in a positional relation in which the meter display unit 12 is exposed and faces the eye point EP with respect to the vehicle longitudinal direction X.

The HUD unit 20 is placed between the windshield WS and the eye point EP with respect to the vehicle longitudinal direction X. The HUD unit 20 is a portion that displays the vehicle information relating to the vehicle V such that the vehicle information can be viewed from the eye point EP, through the image 20A reflected on the windshield WS. More specifically, the HUD unit 20 is placed between the windshield WS and the meter casing 11 of the meter unit 10 with respect to the vehicle longitudinal direction X. The HUD unit 20 outputs display light to the windshield WS, and displays the image 20A formed by the display light that has reflected toward the eye point EP side by the windshield WS, on the windshield WS. For example, similar to the above, the vehicle information displayed by the HUD unit 20 may also include various symbols, figures, and the like that are displayed by being superimposed on the background that is viewed from the eye point EP through the windshield WS, in addition to the speed of the vehicle, output rotation speed of the travel power source, accumulated travel distance, cooling water temperature, remaining amount of fuel, battery charge amount, various types of warning lights, shift position, direction of the direction indicator, navigation information, and the like The vehicle information displayed by the HUD unit 20 may also include information to pay attention to (for example, information relating to pedestrians, surrounding vehicles, obstacles, luggage, and the like) in the vicinity of the vehicle V displayed by a relatively simple figure that can easily allow the passenger and the like to intuitively recognize the information, as intuitive and user-friendly information.

More specifically, the HUD unit 20 includes an HUD casing 21 serving as a casing, an emitting unit 22, a reflecting unit 23, and a control circuit board 24. The HUD unit 20 displays the image 20A on the windshield WS, by reflecting the display light emitted from the emitting unit 22 toward the windshield WS by the reflecting unit 23, and reflecting the display light toward the eye point EP side by the windshield WS. In the HUD unit 20 of the present embodiment, the reflecting unit 23 includes a first intermediate mirror 25, a second intermediate mirror 26, and a final mirror 27. The HUD unit 20 reflects the display light emitted from the emitting unit 22 toward the windshield WS, via three reflection systems of the first intermediate mirror 25, the second intermediate mirror 26, and the final mirror 27 that configure the reflecting unit 23. In this example, the HUD unit 20 causes an HUD display unit WSa of the windshield WS to displays the image 20A. Typically, the HUD display unit WSa is a region determined in advance as a region that can be easily viewed from the eye point EP in the windshield WS, and includes the surface of the windshield WS at the eye point EP side. In the windshield WS, the HUD display unit WSa is provided at a location where the driver DR can view the image 20A to be displayed on the HUD display unit WSa, in a state while the driver DR is looking forward in the traveling direction of the vehicle V. For example, the HUD display unit WSa is provided at a location where the driver DR can view the image 20A to be displayed on the HUD display unit WSa in the peripheral view of the driver DR, in a state while the driver DR is looking straight ahead in the traveling direction of the vehicle V. However, it is not limited thereto, and the HUD display unit WSa may also be provided at a location where the driver DR can view the image 20A to be displayed on the HUD display unit WSa in the center view of the driver DR.

The HUD casing 21 stores the emitting unit 22, a part of the reflecting unit 23 (the first intermediate mirror 25 and the second intermediate mirror 26, which will be described below), the control circuit board 24, and the like in an internal storage space part 28. For example, the meter casing 11 and the HUD casing 21 described above are separately formed of insulating synthetic resin and the like, and are assembled to each other. For example, the HUD casing 21 is formed in a hollow box shape by assembling a plurality of members, and the hollow internal space part forms the storage space part 28. An optical path opening part 21a is formed on the upper surface of the HUD casing 21 in the vehicle height direction Z. The optical path opening part 21a communicates the inside and outside of the HUD casing 21. The optical path opening part 21a forms an optical path opening for guiding the display light emitted from the emitting unit 22 to the outside of the storage space part 28 of the HUD casing 21. Moreover, the optical path opening part 21a guides the display light directed toward the final mirror 27, which will be described below, from the inside of the storage space part 28, to the outside of the storage space part 28. The optical path opening part 21a faces upward in the vehicle height direction Z. In this example, in the HUD casing 21, the optical path opening part 21a is covered by a transparent cover member 21b. The transparent cover member 21b is formed of a light transmissive member that at least transmits the display light emitted from the emitting unit 22. Moreover, in the HUD casing 21, a light shielding wall part 21c is vertically installed on the edge part of the optical path opening part 21a at the front side in the vehicle longitudinal direction X. The light shielding wall part 21c projects upward in the vehicle height direction Z and extends along the vehicle width direction Y. In other words, the light shielding wall part 21c is formed on the edge part of the transparent cover member 21b at the front side in the vehicle longitudinal direction X, along a side of the transparent cover member 21b in the vehicle width direction Y. The light shielding wall part 21c shields the external light at the front side of the transparent cover member 21b in the vehicle longitudinal direction X, and prevents the external light from being reflected by the transparent cover member 21b. The HUD casing 21 is placed between the windshield WS and the meter casing 11 of the meter unit 10 in the vehicle longitudinal direction X, and is installed in the instrument panel IP in a positional relation in which the optical path opening part 21a faces upward in the vehicle height direction Z.

The emitting unit 22 is installed in the vehicle V and can emit the display light. The emitting unit 22 is provided in the storage space part 28 of the HUD casing 21. The display light emitted by the emitting unit 22 is light that expresses the image 20A to be displayed on the HUD display unit WSa of the windshield WS, and at least includes the light having components in the visible light region. The emitting unit 22 is a device that emits the display light. For example, the emitting unit 22 includes a thin liquid crystal display, a plasma display, an organic electroluminescence (EL) display, an optical indicator, a fluorescent display tube, and the like. In the storage space part 28, the emitting unit 22 is provided at the front side in the vehicle longitudinal direction X and at the lower side in the vehicle height direction Z. The emitting unit 22 is also supported inside the storage space part 28 such that the optical axis direction of the display light to be emitted is oriented rearward in the vehicle longitudinal direction X, and upward in the vehicle height direction Z. The emitting unit 22 emits the display light rearward in the vehicle longitudinal direction X and upward in the vehicle height direction Z.

The reflecting unit 23 forms an optical path changing optical system that changes the optical path of the display light emitted by the emitting unit 22. As described above, the reflecting unit 23 of the present embodiment includes the first intermediate mirror 25, the second intermediate mirror 26, and the final mirror 27. The first intermediate mirror 25 is a first intermediate mirror that totally reflects the display light emitted from the emitting unit 22 toward the second intermediate mirror 26. The second intermediate mirror 26 is a second intermediate mirror that totally reflects the display light that is emitted from the emitting unit 22 and that is reflected by the first intermediate mirror 25, toward the final mirror 27. The final mirror 27 is a mirror of the last stage that totally reflects the display light that is emitted from the emitting unit 22, and that is reflected by the first intermediate mirror 25 and the second intermediate mirror 26, toward the HUD display unit WSa of the windshield WS. The final mirror 27 totally reflects the display light toward the HUD display unit WSa of the windshield WS, and reflects the display light toward the eye point EP side by the HUD display unit WSa of the windshield WS. The first intermediate mirror 25, the second intermediate mirror 26, and the final mirror 27 may each be what is called a planar mirror, a magnifying mirror, or a free-curved mirror. The magnifying mirror is formed as a concave mirror or a convex mirror. The magnifying mirror magnifies an image formed by the display light after being reflected so that the image is relatively enlarged, compared to an image formed by the display light before being reflected, and reflects the image. Unlike a spherical or paraboloidal mirror, the free-curved mirror is formed as a mirror asymmetric with respect to the optical axis, and may also be referred to as an aspherical mirror. In other words, the free-curved mirror is a concave mirror or a convex mirror, and is formed as a mirror asymmetric with respect to the optical axis. The free-curved mirror is formed into a shape corresponding to the surface shape of the HUD display unit WSa, and a geometric positional relation of the optical reflection systems such as the first intermediate mirror 25, the second intermediate mirror 26, the final mirror 27, and the like. The free-curved mirror reflects the display light such that the image 20A formed by the display light that has reflected on the HUD display unit WSa is formed into a desired shape in the end. In this example, in the reflecting unit 23, the first intermediate mirror 25 and the second intermediate mirror 26 are configured by the free-curved mirror, and the final mirror 27 is configured by the planar mirror.

Then, in the reflecting unit 23 of the present embodiment, the first intermediate mirror 25 and the second intermediate mirror 26 are provided inside the storage space part 28 of the HUD casing 21, and the final mirror 27 is provided outside the storage space part 28. In the storage space part 28, the first intermediate mirror 25 is provided at the rear side in the vehicle longitudinal direction X and at a location that faces the emitting unit 22 along the vehicle longitudinal direction X. The first intermediate mirror 25 is also supported inside the storage space part 28 such that the optical axis direction of the display light to be reflected is oriented forward in the vehicle longitudinal direction X, and downward in the vehicle height direction Z. The first intermediate mirror 25 reflects the display light forward in the vehicle longitudinal direction X and downward in the vehicle height direction Z. In the storage space part 28, the second intermediate mirror 26 is provided at the front side in the vehicle longitudinal direction X, and at a location that faces the first intermediate mirror 25 along the vehicle longitudinal direction X. In this example, the second intermediate mirror 26 is provided on the upper side of the emitting unit 22 with respect to the vehicle height direction Z. The second intermediate mirror 26 is also supported inside the storage space part 28 such that the optical axis direction of the display light to be reflected is oriented rearward in the vehicle longitudinal direction X, and upward in the vehicle height direction Z. The second intermediate mirror 26 reflects the display light rearward in the vehicle longitudinal direction X and upward in the vehicle height direction Z. The display light reflected by the second intermediate mirror 26 is guided from the inside of the storage space part 28 to the outside of the storage space part 28 via the optical path opening part 21a and the transparent cover member 21b, and is directed toward the final mirror 27. At the outside of the storage space part 28, the final mirror 27 is placed between the windshield WS and the eye point EP with respect to the vehicle longitudinal direction X, and at a location that faces the windshield WS. The final mirror 27 of the present embodiment is placed between the windshield WS and the meter casing 11 of the meter unit 10. By being provided on a rear surface 11a of the meter casing 11 of the meter unit 10, the entire final mirror 27 is provided outside the storage space part 28. In this example, the rear surface 11a of the meter casing 11 is a surface at the front side in the vehicle longitudinal direction X and a surface opposite to the meter display unit 12. The final mirror 27 is supported by the rear surface 11a of the meter casing 11 such that the optical axis direction of the display light to be reflected is oriented forward in the vehicle longitudinal direction X, and upward in the vehicle height direction Z. The final mirror 27 reflects the display light forward in the vehicle longitudinal direction X and upward in the vehicle height direction Z. For example, the final mirror 27 reflects the display light entered at an incident angle α toward the HUD display unit WSa of the windshield WS at a reflection angle (emission angle) α. Then, the HUD display unit WSa of the windshield WS reflects the display light that has entered from the final mirror 27 at an incident angle β, at a reflection angle (emission angle) β. For example, in the HUD unit 20, while the units are installed in the instrument panel IP, the angle α and the like that configure the optical system are suitably adjusted such that the display light reflected by the HUD display unit WSa reaches the eye point EP. Moreover, the configuration of the HUD unit 20 may be implement, by adjusting the various angles of the first intermediate mirror 25 and the second intermediate mirror 26 that configure the optical system.

The control circuit board 24 is electrically connected to the units in the HUD unit 20 including the emitting unit 22, and controls the operations of the units in the HUD unit 20 including the emitting unit 22. In this example, the control circuit board 24 is also electrically connected to the meter unit 10, and controls the operations of the units in the meter unit 10. Moreover, the control circuit board 24 is also electrically connected to the vehicle electronic control unit (ECU) or the like that integrally controls the units in the vehicle V, and can send and receive various signals to each other. In this example, the control circuit board 24 is provided inside the storage space part 28. However, the control circuit board 24 may also be provided outside the storage space part 28. Moreover, the control circuit board 24 may also control the overall operation of the vehicle display device 1 including the meter unit 10 in addition to the HUD unit 20.

In the HUD unit 20 configured as described above, the display light that is emitted from the emitting unit 22 and that corresponds to the information to be displayed is reflected toward the final mirror 27 via the first intermediate mirror 25 and the second intermediate mirror 26 that configure the reflecting unit 23. In the HUD unit 20, the display light reflected by the second intermediate mirror 26 reaches the final mirror 27 that configures the reflecting unit 23, via the optical path opening part 21a and the transparent cover member 21b. The display light is reflected toward the HUD display unit WSa of the windshield WS by the final mirror 27. Then, in the HUD unit 20, the display light reflected by the final mirror 27 reaches the HUD display unit WSa of the windshield WS, and is reflected toward the eye point EP side by the HUD display unit WSa. With this configuration, in the HUD unit 20, the image 20A formed by the display light is displayed on the HUD display unit WSa. The image 20A is a reflected image formed by the display light reflected toward the eye point EP side by the HUD display unit WSa, and is what is called a virtual image that can be viewed from the eye point EP. In this manner, the HUD unit 20 can display a virtual image of the image 20A relating to the vehicle information formed by the display light on the HUD display unit WSa.

In the vehicle display device 1 described above, the display light that is emitted from the emitting unit 22 and that is reflected toward the windshield WS by the final mirror 27 is reflected toward the eye point EP side by the windshield WS. With this configuration, the vehicle display device 1 can display the image 20A formed by the display light on the windshield WS. In this example, the vehicle display device 1 displays the image 20A formed by the display light described above on the windshield WS the rise angle θ of which at the eye point EP side with respect to the horizontal direction is 60 degrees or more and 90 degrees or less. In this case, the vehicle display device 1 is disposed in a geometric positional relation in which the final mirror 27 is placed between the windshield WS and the eye point EP with respect to the vehicle longitudinal direction X, faces the windshield WS, and reflects the display light emitted from the emitting unit 22 forward in the vehicle longitudinal direction X. With this configuration, the vehicle display device 1 can let the display light enter the windshield WS having the rise angle θ as described above at a suitable angle, while being disposed in a limited space between the windshield WS and the eye point EP. As a result, the vehicle display device 1 can suitably display a virtual image of the image 20A formed by the display light on the windshield WS having the rise angle θ as described above such that the virtual image of the image 20A can be viewed from the eye point EP. In other words, the vehicle display device 1 can be laid out on a location that does not interfere with an operation of the driver DR and the like, while displaying a virtual image of the image 20A formed by the display light on the windshield WS having the rise angle θ as described above. As a result, the vehicle display device 1 can suitably display the image 20A formed by the display light on the windshield WS that rises from the horizontal direction.

Moreover, in the vehicle display device 1 described above, the final mirror 27 is provided outside the storage space part 28 of the HUD casing 21 in which the emitting unit 22 and the like are stored. With this configuration, the vehicle display device 1 can suitably implement the geometric positional relation in which the final mirror 27 is placed between the windshield WS and the eye point EP with respect to the vehicle longitudinal direction X, faces the windshield WS, and reflects the display light forward in the vehicle longitudinal direction X.

Furthermore, in the vehicle display device 1 described above, the final mirror 27 is placed between the windshield WS and the meter unit 10 with respect to the vehicle longitudinal direction X, and is provided on the rear surface 11a that is a surface at the front side of the meter unit 10 in the vehicle longitudinal direction X. With this configuration, while effectively utilizing the dead space between the windshield WS and the meter unit 10, and disposing the final mirror 27, the vehicle display device 1 can suitably display the image 20A formed by the display light on the windshield WS. As a result, for example, it is possible to reduce the overall size of the vehicle display device 1, by eliminating the portion that protrudes toward the driver DR side as much as possible. Moreover, by integrally unitizing the meter unit 10 and the HUD unit 20, the vehicle display device 1 can be collectively installed on the vehicle V. Consequently, it is possible to improve the mountability of the vehicle display device 1.

### Second Embodiment

A vehicle display device according to a second embodiment is different from the first embodiment in including a display position adjustment unit. In the following, the same reference numerals denote the same components as those in the embodiment described above, and repeated description of the configuration, operation, and effects common to those in the embodiment described above will be omitted as much as possible (the same applies hereinafter).

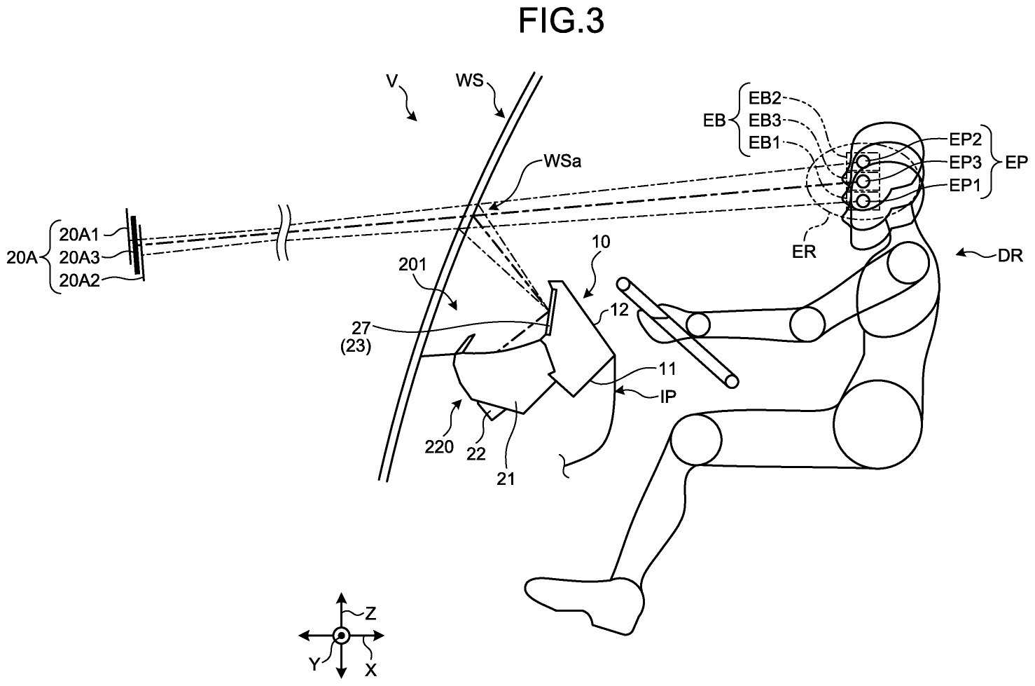

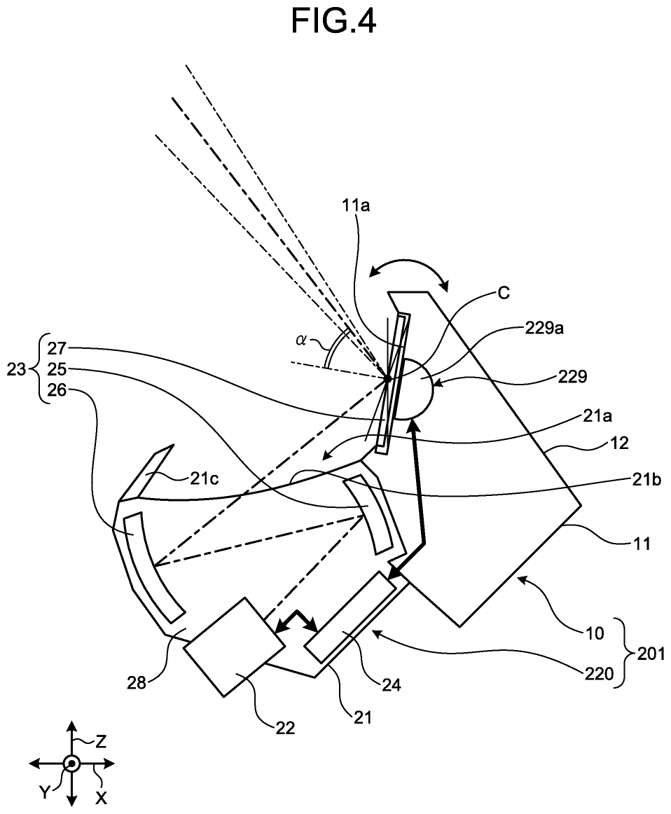

A vehicle display device 201 according to the present embodiment illustrated in FIG. 3 and FIG. 4 is different from the vehicle display device 1 described above in including an HUD unit 220 instead of the HUD unit 20. The other configuration of the vehicle display device 201 is substantially the same as that of the vehicle display device 1. The HUD unit 220 is different from the HUD unit 20 described above in including a display position adjustment unit 229. The other configuration of the HUD unit 220 is substantially the same as that of the HUD unit 20.

The display position adjustment unit 229 is a mechanism that can adjust the display position of the image 20A formed by the display light that has reflected toward the eye point EP side by the HUD display unit WSa of the windshield WS. For example, the eye box EB and the eye point EP assumed in the vehicle V fluctuate along the vehicle height direction Z according to the physique and posture of the driver DR, the height of the seat surface on which the driver DR is seated, and the like. The display position adjustment unit 229 adjusts the display position of the image 20A formed by the display light so that the image 20A is suitably placed, according to the fluctuation of the eye box EB and the eye point EP along the vehicle height direction Z.

More specifically, the display position adjustment unit 229 adjusts the reflection angle α of the display light that reflects toward the windshield WS by the final mirror 27, by rotating the final mirror 27 around a rotation axis line C along the vehicle width direction Y. With this configuration, the display position adjustment unit 229 can adjust the display position of the image 20A formed by the display light reflected toward the eye point EP side by the HUD display unit WSa of the windshield WS.

The display position adjustment unit 229 of the present embodiment includes a driving actuator 229a provided on the surface at the rear side of the final mirror 27 in the vehicle longitudinal direction X. The driving actuator 229a includes a motor and the like, and causes the final mirror 27 to rotate around the rotation axis line C that is set in the vicinity of the final mirror 27, by driving the motor. The display position adjustment unit 229 can change the reflection angle a by causing the driving actuator 229a to rotate the final mirror 27 around the rotation axis line C.

For example, when the eye box EB and the eye point EP are located on a relatively lower side in the vehicle height direction Z (see an eye box EB1 and an eye point EP1 in FIG. 3), the display position adjustment unit 229 rotates the final mirror 27 around the rotation axis line C, and relatively increases the reflection angle α. Consequently, the display position adjustment unit 229 sets the display position of the image 20A formed by the display light on a relatively upper side in the vehicle height direction Z (see an image 20A1 in FIG. 3). On the other hand, for example, when the eye box EB and the eye point EP are located on a relatively upper side in the vehicle height direction Z (see an eye box EB2 and an eye point EP2 in FIG. 3), the display position adjustment unit 229 rotates the final mirror 27 around the rotation axis line C, and relatively reduces the reflection angle α. Consequently, the display position adjustment unit 229 sets the display position of the image 20A formed by the display light on a relatively lower side in the vehicle height direction Z (see an image 20A2 in FIG. 3). Moreover, for example, when the eye box EB and the eye point EP are located in the center of the two examples described above in the vehicle height direction Z (see an eye box EB3 and an eye point EP3 in FIG. 3), the display position adjustment unit 229 rotates the final mirror 27 around the rotation axis line C, and sets the reflection angle α to the angle at the center of the two examples described above. Consequently, the display position adjustment unit 229 sets the display position of the image 20A formed by the display light to the center of the two examples described above in the vehicle height direction Z (see an image 20A3 in FIG. 3).

The display position adjustment unit 229 is electrically connected to the control circuit board 24, and the operation thereof is controlled by the control circuit board 24. For example, the control circuit board 24 may also adjust the display position of the image 20A formed by the display light, by controlling the display position adjustment unit 229 on the basis of an input operation performed by the driver DR and the like on an operation unit, and adjusting the reflection angle α of the final mirror 27. Moreover, for example, the control circuit board 24 may automatically adjust the display position of the image 20A formed by the display light, by controlling the display position adjustment unit 229 on the basis of the detection result obtained by a detection unit for detecting the eye point EP of the driver DR, and by automatically adjusting the reflection angle α of the final mirror 27.

The vehicle display device 201 described above can suitably display the image 20A formed by the display light on the windshield WS that rises from the horizontal direction.

Thus, the vehicle display device 201 described above can adjust the display position of the image 20A formed by the display light that has reflected toward the eye point EP side by the HUD display unit WSa of the windshield WS to a suitable position, by rotating the final mirror 27 around the rotation axis line C and adjusting the reflection angle α by the display position adjustment unit 229. In this case, the display position adjustment unit 229 adjusts the reflection angle α of the final mirror 27 among a plurality of the reflection systems (first intermediate mirror 25, second intermediate mirror 26, and final mirror 27) that configure the reflecting unit 23. With this configuration, the display position adjustment unit 229 can adjust the display position of the image 20A formed by the display light to a suitable position, by adjusting the reflection angle α of the final mirror 27 that is closer to the HUD display unit WSa of the windshield WS, while relatively reducing the adjustment width of the reflection angle α. As a result, the vehicle display device 201 can suitably display the image 20A formed by the display light on the windshield WS that rises from the horizontal direction.

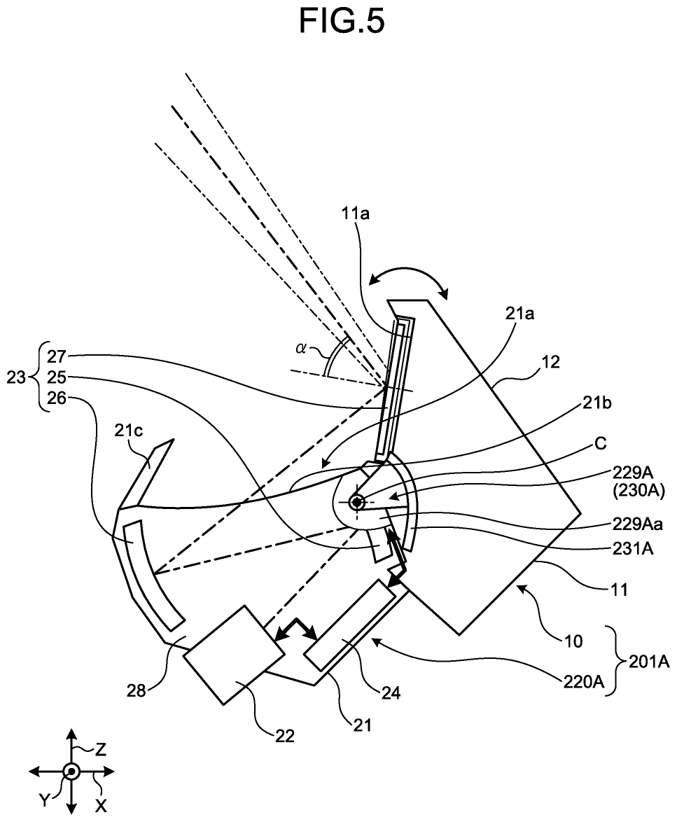

It is to be noted that the configuration of the display position adjustment unit 229 described above is not limited to the above. An HUD unit 220A in a vehicle display device 201A according to a modification illustrated in FIG. 5 is different from the HUD unit 220 described above, in including a display position adjustment unit 229A instead of the display position adjustment unit 229. The other configuration of the vehicle display device 201A is substantially the same as that of the HUD unit 220. The display position adjustment unit 229A includes a driving actuator 229Aa provided on an end portion at the lower side of the final mirror 27 in the vehicle height direction Z. The driving actuator 229Aa includes a motor and the like, and causes the final mirror 27 to rotate around the rotation axis line C that is set on the end portion at the lower side of the final mirror 27 in the vehicle height direction Z, by driving the motor. The display position adjustment unit 229A can change the reflection angle α by causing the driving actuator 229Aa to rotate the final mirror 27 around the rotation axis line C. With this configuration, the display position adjustment unit 229A can adjust the display position of the image 20A formed by the display light that has reflected toward the eye point EP side by the HUD display unit WSa of the windshield WS. In this case also, the vehicle display device 201A can adjust the display position of the image 20A formed by the display light that has reflected toward the eye point EP side by the HUD display unit WSa of the windshield WS to a suitable position.

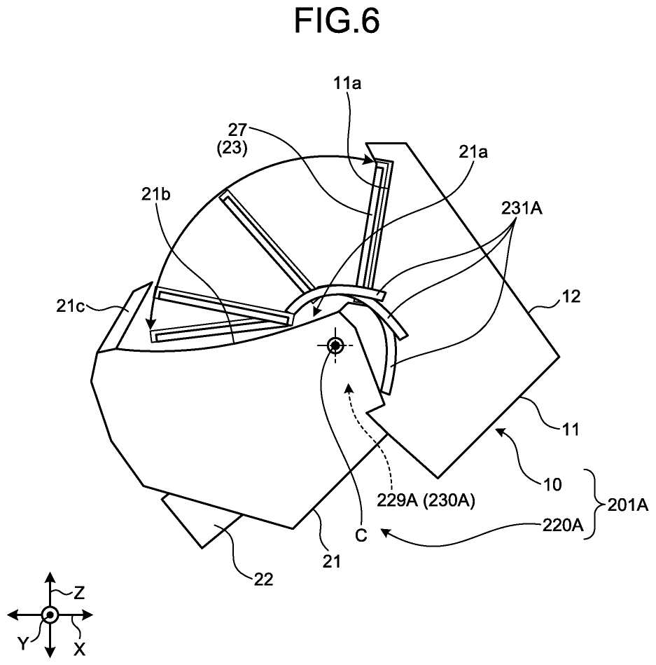

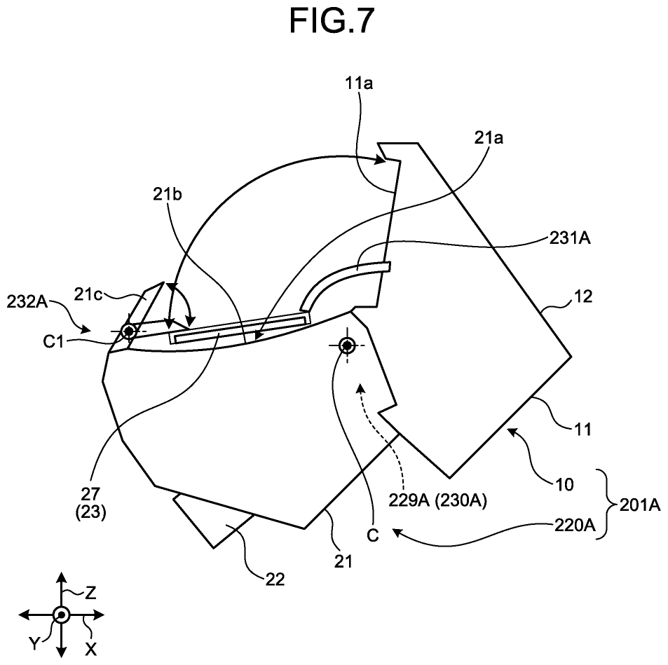

In this case, the display position adjustment unit 229A can also be used as an opening opening/closing driving unit 230A for opening and closing the optical path opening part 21a formed on the HUD casing 21. The display position adjustment unit 229A, also used as the opening opening/closing driving unit 230A, can move between the display position illustrated in FIG. 5 and FIG. 6, and the non-display position illustrated in FIG. 6 and FIG. 7, by causing the final mirror 27 to rotate around the rotation axis line C. The display position of the final mirror 27 is a position where the optical path opening part 21a formed on the HUD casing 21 is opened, and the final mirror 27 is placed between the windshield WS and the eye point EP with respect to the vehicle longitudinal direction X as described above and faces the windshield WS. The display position is a position to display the image 20A (see FIG. 3 and the like), where the final mirror 27 reflects the display light emitted from the emitting unit 22 toward the windshield WS at the front side in the vehicle longitudinal direction X, and the display light is reflected toward the eye point EP side by the windshield WS. On the other hand, the non-display position of the final mirror 27 is a position where the final mirror 27 closes the optical path opening part 21a formed on the HUD casing 21. The non-display position is a position where the image 20A (see FIG. 3 and the like) is not to be displayed on the windshield WS.

The display position adjustment unit 229A, also used as the opening opening/closing driving unit 230A, is electrically connected to the control circuit board 24, and the operation thereof is controlled by the control circuit board 24. To display the image 20A formed by the display light, the control circuit board 24 controls the display position adjustment unit 229A also used as the opening opening/closing driving unit 230A, and sets the final mirror 27 as the display position. On the other hand, when the image 20A formed by the display light is not to be displayed, the control circuit board 24 controls the display position adjustment unit 229A also used as the opening opening/closing driving unit 230A, and sets the final mirror 27 as the non-display position.

The vehicle display device 201A according to the modification described above can display the image 20A formed by the display light, when the final mirror 27 is set as the display position, by the display position adjustment unit 229A that is also used as the opening opening/closing driving unit 230A. On the other hand, the vehicle display device 201A can cause the final mirror 27 to function as a lid for the optical path opening part 21a, when the final mirror 27 is set as the non-display position by the display position adjustment unit 229A that is also used as the opening opening/closing driving unit 230A. As a result, when the image 20A formed by the display light is not to be displayed on the final mirror 27, the vehicle display device 201A can prevent intrusion of foreign matters, accumulation of dust, or the like inside the HUD casing 21 via the optical path opening part 21a, by causing the final mirror 27 to function as the lid for the optical path opening part 21a.

In such a case, as illustrated in FIG. 5 and FIG. 6, the HUD unit 220A of the vehicle display device 201A may also include a cover member 231A that is provided around the rotation axis line C, and that rotates with the rotation of the final mirror 27 accompanied by the final mirror 27. When the final mirror 27 is at the non-display position, the cover member 231A closes a gap in the vicinity of the rotation axis line C of the optical path opening part 21a. When the final mirror 27 is at the display position, the cover member 231A opens the gap. With this configuration, the vehicle display device 201A can prevent intrusion of foreign matters, accumulation of dust, or the like inside the HUD casing 21 via the optical path opening part 21a more assuredly.

Moreover, in this case, as illustrated in FIG. 7, the HUD unit 220A of the vehicle display device 201A may also include a driving actuator 232A that can move between the upright position and the closed position, by causing the light shielding wall part 21c to rotate around a rotation axis line C1 along the vehicle width direction Y. Similar to the driving actuators 229a and 229Aa, the driving actuator 232A includes a motor and the like, and causes the light shielding wall part 21c to rotate around the rotation axis line C1 set on an end portion at the lower side of the light shielding wall part 21c in the vehicle height direction Z, by driving the motor. The upright position of the light shielding wall part 21c is a position where the light shielding wall part 21c projects upward in the vehicle height direction Z, shields the external light with respect to the transparent cover member 21b, and prevents the external light from being reflected by the transparent cover member 21b. On the other hand, the closing position of the light shielding wall part 21c is a position where the light shielding wall part 21c closes the gap opposite to the rotation axis line C side of the optical path opening part 21a. The driving actuator 232A is electrically connected to the control circuit board 24, and the operation thereof is controlled by the control circuit board 24. When the final mirror 27 is at the display position, the control circuit board 24 controls the driving actuator 232A, and sets the light shielding wall part 21c to the upright position. On the other hand, when the final mirror 27 is at the non-display position, the control circuit board 24 controls the driving actuator 232A, and sets the light shielding wall part 21c to the closing position. With this configuration, the vehicle display device 201A can prevent intrusion of foreign matters, accumulation of dust, or the like inside the HUD casing 21 via the optical path opening part 21a more assuredly.

The vehicle display device according to the embodiments and modification of the present invention described above are not limited to the embodiments and modification described above, and various modifications may be made within the spirit and scope of the appended claims. The vehicle display device according to the present embodiments and modification may be configured by suitably combining the components of the embodiments and modification described above.

The vehicle display device 1, 201, or 201A described above exhibits the effects more preferably, when the vehicle display device 1, 201, or 201A described above is applied to the vehicle V in which the rise angle θ of the windshield WS is 70 degrees or more and 90 degrees or less (70°≤θ≤90°), or more preferably, 80 degrees or more and 90 degrees or less (80°≤θ≤90°).

In the above explanation, the vehicle display device 1, 201, or 201A is a display device unit in which the meter unit 10 and the HUD unit 20, 220, or 220A are integrally unitized. However, it is not limited thereto. The vehicle display device 1, 201, or 201A may not include the meter unit 10, and may only include the HUD unit 20, 220, or 220A.

In the above explanation, in the HUD unit 20, 220, or 220A, the reflecting unit 23 includes the first intermediate mirror 25, the second intermediate mirror 26, and the final mirror 27. However, it is not limited thereto. The HUD unit 20, 220, or 220A may at least include the final mirror 27, and may not include the first intermediate mirror 25 and the second intermediate mirror 26. Alternatively, the HUD unit 20, 220, or 220A may include three or more intermediate mirrors.

In the above explanation, the entire final mirror 27 is provided outside the storage space part 28. However, it is not limited thereto. Only a part of the final mirror 27 may be provided outside the storage space part 28, or the entire final mirror 27 may be provided inside the storage space part 28. Even in this case, the final mirror 27 may be placed between the windshield WS and the eye point EP with respect to the vehicle longitudinal direction X, faces the windshield WS, and provided at a location that reflects the display light emitted from the emitting unit 22 forward in the vehicle longitudinal direction X.

In the above explanation, the display position adjustment unit 229A is also used as the opening opening/closing driving unit 230A. However, it is not limited thereto. The display position adjustment unit 229A and the opening opening/closing driving unit 230A may also be formed separately.

A vehicle display device according to the present embodiment can display an image formed by display light that is emitted from an emitting unit and that is reflected toward a windshield by a final mirror, on the windshield, by reflecting the display light toward an eye point side by the windshield. In this example, the vehicle display device displays the display light on the windshield in which the rise angle at the eye point side with respect to the horizontal direction is 60 degrees or more and 90 degrees or less. In this case, the vehicle display device is disposed in a geometric positional relation in which the final mirror is placed between the windshield and the eye point with respect to the vehicle longitudinal direction, faces the windshield, and reflects the display light emitted from the emitting unit forward in the vehicle longitudinal direction. With this configuration, the vehicle display device can suitably display an image formed by the display light on the windshield that has the rise angle as described above such that the image is visible from the eye point. As a result, the vehicle display device can suitably display an image formed by the display light on the windshield that rises from the horizontal direction.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle display device, comprising:
an emitting unit that is installed on a vehicle and that emits display light;
a final mirror that reflects the display light emitted from the emitting unit toward a windshield provided in a front part of the vehicle in a vehicle longitudinal direction, and that reflects by the windshield the display light toward a side of an eye point assumed in advance, and
a casing that stores the emitting unit in an internal storage space part, wherein
the final mirror is placed between the windshield and the eye point with respect to the vehicle longitudinal direction, faces the windshield, and reflects the display light emitted from the emitting unit forward in the vehicle longitudinal direction,
the casing includes an optical path opening part that guides the display light from an inside of the storage space part to an outside of the storage space part, and
the vehicle display device further comprises:
an opening opening/closing driving unit capable of moving the final mirror between a display position and a non-display position, the display position being a position where the final mirror is placed between the windshield and the eye point with respect to the vehicle longitudinal direction, faces the windshield, reflects the display light emitted from the emitting unit toward the windshield at a front side in the vehicle longitudinal direction, and reflects the display light toward the side of the eye point by the windshield, and a non-display position being a position where the final mirror closes the optical path opening part.

2. The vehicle display device according to claim 1, further comprising:
a display position adjustment unit capable of adjusting a display position of an image formed by the display light that has reflected toward the side of the eye point by the windshield, by adjusting a reflection angle of the display light that is reflected toward the windshield by the final mirror, by causing the final mirror to rotate around a rotation axis line along a vehicle width direction intersecting with the vehicle longitudinal direction.

3. The vehicle display device according to claim 1, further comprising:
the final mirror is provided outside the storage space part, wherein
the optical path opening part guides the display light directed toward the final mirror from the inside of the storage space part, to the outside of the storage space part.

4. The vehicle display device according to claim 2, further comprising:
the final mirror is provided outside the storage space part, wherein
the optical path opening part guides the display light directed toward the final mirror from the inside of the storage space part, to the outside of the storage space part.

5. The vehicle display device according to claim 1, wherein
a rise angle of the windshield at the side of the eye point with respect to a horizontal direction is 60 degrees or more and 90 degrees or less.

6. The vehicle display device according to claim 2, wherein
a rise angle of the windshield at the side of the eye point with respect to a horizontal direction is 60 degrees or more and 90 degrees or less.

7. The vehicle display device according to claim 3, wherein
a rise angle of the windshield at the side of the eye point with respect to a horizontal direction is 60 degrees or more and 90 degrees or less.

8. The vehicle display device according to claim 4, wherein
a rise angle of the windshield at the side of the eye point with respect to a horizontal direction is 60 degrees or more and 90 degrees or less.

9. The vehicle display device according to claim 1, further comprising:
a meter unit that is placed between the windshield and the eye point with respect to the vehicle longitudinal direction, and that visibly displays vehicle information relating to the vehicle at the eye point, wherein
the final mirror is placed between the windshield and the meter unit with respect to the vehicle longitudinal direction, and is provided on a surface at a front side of the meter unit in the vehicle longitudinal direction.

10. The vehicle display device according to claim 2, further comprising:
a meter unit that is placed between the windshield and the eye point with respect to the vehicle longitudinal direction, and that visibly displays vehicle information relating to the vehicle at the eye point, wherein
the final mirror is placed between the windshield and the meter unit with respect to the vehicle longitudinal direction, and is provided on a surface at a front side of the meter unit in the vehicle longitudinal direction.

11. The vehicle display device according to claim 3, further comprising:
a meter unit that is placed between the windshield and the eye point with respect to the vehicle longitudinal direction, and that visibly displays vehicle information relating to the vehicle at the eye point, wherein
the final mirror is placed between the windshield and the meter unit with respect to the vehicle longitudinal direction, and is provided on a surface at a front side of the meter unit in the vehicle longitudinal direction.

12. The vehicle display device according to claim 4, further comprising:
a meter unit that is placed between the windshield and the eye point with respect to the vehicle longitudinal direction, and that visibly displays vehicle information relating to the vehicle at the eye point, wherein
the final mirror is placed between the windshield and the meter unit with respect to the vehicle longitudinal direction, and is provided on a surface at a front side of the meter unit in the vehicle longitudinal direction.

13. The vehicle display device according to claim 5, further comprising:
a meter unit that is placed between the windshield and the eye point with respect to the vehicle longitudinal direction, and that visibly displays vehicle information relating to the vehicle at the eye point, wherein
the final mirror is placed between the windshield and the meter unit with respect to the vehicle longitudinal direction, and is provided on a surface at a front side of the meter unit in the vehicle longitudinal direction.

14. The vehicle display device according to claim 6, further comprising:
a meter unit that is placed between the windshield and the eye point with respect to the vehicle longitudinal direction, and that visibly displays vehicle information relating to the vehicle at the eye point, wherein
the final mirror is placed between the windshield and the meter unit with respect to the vehicle longitudinal direction, and is provided on a surface at a front side of the meter unit in the vehicle longitudinal direction.

15. The vehicle display device according to claim 7, further comprising:
a meter unit that is placed between the windshield and the eye point with respect to the vehicle longitudinal direction, and that visibly displays vehicle information relating to the vehicle at the eye point, wherein
the final mirror is placed between the windshield and the meter unit with respect to the vehicle longitudinal direction, and is provided on a surface at a front side of the meter unit in the vehicle longitudinal direction.

16. The vehicle display device according to claim 8, further comprising:
a meter unit that is placed between the windshield and the eye point with respect to the vehicle longitudinal direction, and that visibly displays vehicle information relating to the vehicle at the eye point, wherein
the final mirror is placed between the windshield and the meter unit with respect to the vehicle longitudinal direction, and is provided on a surface at a front side of the meter unit in the vehicle longitudinal direction.
